(19) United States
(12) Patent Application Publication
(10) Pub. No.: US 2026/0049015 A1
(43) Pub. Date: Feb. 19, 2026

(54) TAIL WATER TREATMENT AND RECYCLING SYSTEM FOR AQUACULTURE

(71) Applicant: Pearl River Fisheries Research Institute (PRFRI), Chinese Academy of Fishery Sciences (CAFS), Guangzhou (CN)

(72) Inventors: Zhifei Li, Guangzhou (CN); Jun Xie, Guangzhou (CN); Guangjun Wang, Guangzhou (CN); Junlin Li, Guangzhou (CN); Wangbao Gong, Guangzhou (CN); Kai Zhang, Guangzhou (CN); Yun Xia, Guangzhou (CN); Jingjing Tian, Guangzhou (CN); Hongyan Li, Guangzhou (CN); Wenping Xie, Guangzhou (CN)

(21) Appl. No.: 19/020,751

(22) Filed: Jan. 14, 2025

(30) Foreign Application Priority Data
Aug. 13, 2024 (CN) 202411113459.2

(51) Int. Cl. C02F 9/00; C02F 1/00; C02F 3/00; C02F 103/20

(52) U.S. Cl. CPC C02F 9/00; C02F 1/00; C02F 2001/007; C02F 3/00; C02F 2103/20; C02F 2209/003

(57) ABSTRACT

Provided is a tail water treatment and recycling system for aquaculture configured to identify the overall water body inside the aquaculture pond to determine the distribution status information of tail water within the pond. It also performs non-contact scanning detection on the water body inside the sedimentation tank, analyzes the sedimentation movement data of sediments within the tank, and evaluates this data to ensure maximum sediment settlement. Furthermore, it determines the reaction progress information inside the decomposition tank, and subsequently adjusts the environmental conditions for decomposition reactions within the tank, effectively reducing the nutrient concentration in the tail water. According to the oxygen content of the water body in the pond, it also adjusts the oxygenation operation for the tail water that has undergone decomposition, ensuring that the pond can continuously and stably receive a supply of clean, high-oxygen recycled water.

### TECHNICAL FIELD

This application relates to the field of water treatment, particularly to the tail water treatment and recycling system for aquaculture.

### BACKGROUND

Water quality is a necessary consideration in aquaculture. During the process of aquaculture, the metabolic activities of aquatic products discharge metabolites into the water body and consume oxygen within it, deteriorating the water quality and failing to provide a clean and stable water environment for the growth of aquatic products. In order to ensure a stable and continuous supply of clean water circulation for aquaculture, it is necessary to promptly extract and purify the tail water from the aquaculture ponds and then reinject the purified tail water back into the ponds to achieve effective water circulation within the ponds. The existing tail water recycling and purification treatment only involves continuous extraction and purification of tail water from specific areas of the aquaculture ponds, and then directed reinjection of the purified tail water back into the ponds. However, it does not comprehensively treat the tail water based on the actual distribution of tail water in the ponds, and cannot guarantee effective purified water circulation throughout the entire water body of the ponds.

### SUMMARY

The purpose of this application is to provide a tail water treatment and recycling system for aquaculture that identifies the global water body inside the aquaculture ponds to determine the distribution status of tail water within the ponds, thereby adjusting the operational status of tail water extraction from the ponds to ensure comprehensive and complete extraction of tail water. The system also performs non-contact scanning and detection of the water body inside the sedimentation tank, analyzes data on the sediment settlement dynamics within the sedimentation tank, and evaluates this data to determine whether sedimentation in the tank is complete, ensuring comprehensive and thorough precipitation and filtration of sediments. Furthermore, the system monitors the tail water decomposition process inside the decomposition tank to obtain output data on the decomposition reaction, thereby determining the reaction progress information within the tank and subsequently adjusting the environmental conditions for the decomposition reaction inside the tank to maximize the biological decomposition reaction and effectively reduce the nutrient concentration in the tail water. Additionally, based on real-time aquaculture status information from the ponds, the system adjusts the delivery status of tail water that has completed the decomposition reaction for recirculation into the ponds. It also adjusts the oxygenation operation for the tail water that has completed the decomposition reaction based on the oxygen content of the water body in the ponds, ensuring that the ponds can continuously and stably receive a supply of clean, high-oxygen recycled water.

The present application is implemented through the following technical solution.

A tail water treatment and recycling system for aquaculture is provided, comprising:
a tail water distribution identification module for aquaculture ponds configured to identify the global water body inside the aquaculture ponds to determine the status information of tail water distribution within the ponds; and determine the status information of water body areas within the ponds where tail water extraction is needed based on this information;
a tail water extraction control module configured to adjust the operational status of tail water extraction from the ponds based on the water body area status information, thereby transferring the extracted tail water to a sedimentation tank;
a sediment dynamics identification module configured to perform non-contact scanning detection on the water body inside the sedimentation tank to obtain data on sediment settlement dynamics within the tank, and analyze this data to determine whether sedimentation in the tank is complete;
a tail water transfer control module configured to adjust the extraction operational status for transferring tail water inside the sedimentation tank to a decomposition tank based on the water body characteristic information within the tank when sedimentation in the sedimentation tank is complete;
a biological decomposition monitoring module configured to monitor the tail water decomposition process inside the decomposition tank to obtain decomposition reaction output data, and determine the reaction progress information for the decomposition reaction inside the tank based on this data;
a reaction environment adjustment module configured to adjust the environmental conditions for the decomposition reaction inside the decomposition tank based on the reaction progress information;
a water circulation control module configured to adjust the delivery status of tail water that has completed the decomposition reaction for recirculation into the aquaculture ponds based on real-time aquaculture status information from the ponds, and adjust the oxygenation operation for the tail water that has completed the decomposition reaction based on the oxygen content of the water body in the ponds.

Optionally, the tail water distribution identification module for aquaculture ponds is configured to identify the global water body inside the ponds to determine the status information of tail water distribution within the ponds; it determines the status information of all water body areas within the ponds where tail water extraction is needed based on the status information of tail water, wherein,
distributed water quality detection on the global water body inside the ponds is performed to obtain pollutant concentration change data for different areas of the global water body; this data is analyzed to obtain the average pollutant concentration value and pollutant concentration change rate value for each area over a preset time period; if the average pollutant concentration value is greater than a preset concentration threshold and the pollutant concentration change rate value is less than a preset rate threshold, then the area is classified as a tail water presence area, and the location information of the tail water presence area within the ponds is calibrated, serving as the tail water distribution status information;
water flow detection is performed separately on all tail water presence areas within the ponds based on this information to obtain water flow velocity information for each area, and this information along with water volume information is configured as the water body area status information for tail water extraction within the ponds.

Optionally, the tail water extraction control module is configured to adjust the operational status of tail water extraction from the ponds based on the water body area status information, thereby transferring the extracted tail water to a sedimentation tank, wherein,
water flow simulation processing is performed on these areas based on the water flow velocity information and water volume information for the tail water presence areas to determine the water flow path information within them; the extraction direction and extraction rate for tail water extraction in these areas are adjusted based on the water flow path information, transferring the extracted tail water to the sedimentation tank.

Optionally, the sediment dynamics identification module is configured to perform non-contact scanning detection on the water body inside the sedimentation tank to obtain data on sediment settlement dynamics within the tank; this data is analyzed to determine whether sedimentation in the tank is complete, wherein,
laser illumination detection on the water body inside the sedimentation tank during the sedimentation process is performed to obtain scattering spectrum characteristic information for the water body when illuminated by the laser; sediment settlement velocity distribution data for the water body inside the sedimentation tank is obtained based on the scattering spectrum characteristic information; this data includes sediment settlement velocity distribution data for all sediments on cross-sections corresponding to different water depths within the tank;
this data is analyzed to obtain sediment settlement velocity change trend information within the tank; and whether sedimentation in the tank is complete is determined based on sediment settlement velocity change trend information.

Optionally, the sediment dynamics identification module is configured to perform non-contact scanning detection on the water body inside the sedimentation tank to obtain data on sediment settlement dynamics within the tank; this data is analyzed to determine whether sedimentation in the tank is complete, wherein,
Step S1: during non-contact scanning detection of the water body inside the sedimentation tank, multiple directions of non-contact scanning detection are performed on the water body, and the following formula (1) is configured to screen out the main detection direction for continued scanning detection based on the sediment settlement dynamics data for the water body inside the tank from multiple directions of non-contact scanning detection,

$$\{ \begin{matrix}A 1 = arg {max}_{α = 1}^{D} [ N ( a ) ] \\ A 2 = arg {max}_{α = 1}^{D} [ \frac{{\sum }_{i = 1}^{N ( a )} {V}_{a} ( i )}{N ( a )} ]\end{matrix} \qquad ( 1 )$$

wherein, in the above formula (1), A1 represents selecting the A1th direction as the primary detection direction for continued scanning and detection; A2 represents selecting the A2th direction as the primary detection direction for continued scanning and detection; N(a) represents the number of precipitates in motion within the sediment settlement action data of the internal water body of the sedimentation basin, obtained through non-contact scanning detection in the ath direction; Va(i) represents the magnitude of the movement speed of the ith precipitate in motion within the sediment settlement action data of the internal water body of the sedimentation basin, obtained through non-contact scanning detection in the ath direction; D represents the total number of directions for non-contact scanning detection;

$$arg {max}_{a = 1}^{D} [ ]$$

indicates the value of a that yields the maximum value within the parentheses when a is substituted into the parentheses from 1 to D;
Step S2: the following formula (2) is configured to determine whether the water body inside the sedimentation tank has completed sedimentation in the primary detection direction based on the sediment settlement motion data of the water body inside the sedimentation tank detected in the primary detection direction,

$$\{ \begin{matrix}P ( A 1 ) = IF [ N ( A 1 ) + \frac{{\sum }_{i = 1}^{N ( A 1 )} {V}_{A 1} ( i )}{N ( A 1 )} = 0 ] \\ P ( A 2 ) = IF [ N ( A 2 ) + \frac{{\sum }_{i = 1}^{N ( A 2 )} {V}_{A 2} ( i )}{N ( A 2 )} = 0 ]\end{matrix} \qquad ( 2 )$$

wherein, in the above formula (2), P(A1) represents the detection value indicating whether precipitation is complete in the A1th direction; P(A2) represents the detection value indicating whether precipitation is complete in the A2th direction; N(A1) represents the number of precipitates in motion within the sediment settlement action data of the internal water body of the sedimentation basin, obtained through non-contact scanning detection in the A1th direction; N(A2) represents the number of precipitates in motion within the sediment settlement action data of the internal water body of the sedimentation basin, obtained through non-contact scanning detection in the A2th direction; VA1(i) represents the magnitude of the movement speed of the ith precipitate in motion within the sediment settlement action data of the internal water body of the sedimentation basin, obtained through non-contact scanning detection in the A1th direction; VA2(i) represents the magnitude of the movement speed of the ith precipitate in motion within the sediment settlement action data of the internal water body of the sedimentation basin, obtained through non-contact scanning detection in the A2th direction; IF[ ] represents a conditional function, which takes a value of 1 if the expression within the parentheses is true, and 0 if the expression within the parentheses is false;

Step S3, the following formula (3) is applied to determine whether the water body inside the sedimentation tank has completely settled based on the detection value indicating whether the settlement in the main detection direction of the water body inside the sedimentation tank is complete,

$$E = IF [ P ( A 1 ) = 1 ] \& IF [ P ( A 2 ) = 1 ] \qquad ( 3 )$$

in the formula (3), E represents the decision value indicating whether the water body inside the sedimentation tank has completely settled; “&” represents the logical AND relationship;

If E=1, it indicates that the water body inside the sedimentation tank has completely settled;

If E=0, it indicates that the water body inside the sedimentation tank has not completely settled.

Optionally, the tail water transfer control module is configured to adjust the extraction operational status for transferring tail water inside the tank to the decomposition tank based on the water body characteristic information within the tank when sedimentation in the sedimentation tank is complete, wherein,
when sedimentation in the sedimentation tank is complete, the water body distribution position of the tail water that has settled and is in a clarified state within the tank is obtained, and the real-time area for extracting and transferring this clarified tail water from the sedimentation tank to the decomposition tank is adjusted based on the water body distribution position of the tail water.

Optionally, the biological decomposition monitoring module is configured to monitor the tail water decomposition process inside the decomposition tank to obtain decomposition reaction output data; determining the reaction progress information for the decomposition reaction inside the tank is determined based on the decomposition reaction output data, wherein,
the tail water decomposition process inside the decomposition tank is monitored to obtain decomposition reaction gas production rate change data and decomposition reaction temperature change data;
these data is analyzed to obtain the reaction progress information for the decomposition reaction inside the tank.

Optionally, the reaction environment adjustment module is configured to adjust the environmental conditions for the decomposition reaction inside the decomposition tank based on the reaction progress information, wherein,
based on the reaction progress information, whether the decomposition reaction inside the decomposition tank is in a completed state is determined; if so, the oxygen supply rate inside the tank is reduced; if not, the oxygen supply rate inside the tank is increased.

Optionally, the water circulation control module is configured to adjust the delivery status of tail water that has completed the decomposition reaction for recirculation into the aquaculture ponds based on real-time aquaculture status information from the ponds; and adjust the oxygenation operation for the tail water that has completed the decomposition reaction based on the oxygen content of the water body in the ponds, wherein,
the water volume deficit information within the ponds is determined based on real-time aquatic species distribution density information from the ponds; the delivery flow rate for recirculating tail water that has completed the decomposition reaction into the ponds is adjusted based on the water volume deficit information; and the oxygen content decline rate for the ponds is determined based on oxygen content change data for the water body in the ponds; the oxygenation delivery rate for the tail water that has completed the decomposition reaction is increased based on this rate.

Compared with the existing technology, the present application offers the following beneficial effects.

The tail water treatment and recycling system for aquaculture provided in this application identifies the overall water body within the aquaculture pond, determining the distribution status of tail water inside, and thereby adjusts the operational status of tail water extraction from the pond to ensure comprehensive and complete extraction of tail water. It also performs non-contact scanning and detection of the water body within the sedimentation tank, analyzes the settlement action data of sediments within the tank, and evaluates this data to judge whether the sedimentation process within the tank is complete, thereby ensuring comprehensive and thorough precipitation and filtration of sediments. Furthermore, it monitors the tail water decomposition process within the decomposition tank to obtain decomposition reaction output data, which is configured to determine the reaction progress information inside the tank. Subsequently, it adjusts the environmental conditions for the decomposition reaction within the tank to maximize the biological decomposition reaction, effectively reducing the nutrient concentration in the tail water. Additionally, based on real-time aquaculture status information from the pond, it adjusts the delivery status of tail water, which has completed the decomposition reaction, back into the pond. And based on the oxygen content of the water body in the pond, it adjusts the oxygenation operation for the treated tail water, ensuring that the pond can continuously and stably receive a supply of clean, high-oxygen recycled water.

### BRIEF DESCRIPTION OF THE DRAWINGS

To more clearly illustrate the technical solutions in the embodiments of the present application or in the prior art, the following provides a brief introduction to the drawings required for describing the embodiments or the prior art. It is evident that the drawings described below merely represent some embodiments of the present application. For those of ordinary skill in the art, other drawings can be obtained based on these drawings without exercising creative efforts. Among them:

FIG. 1 is a structural schematic diagram of a tail water treatment and recycling system for aquaculture provided by the present application.

### DETAILED DESCRIPTION

To make the above objectives, features, and advantages of the present application more apparent and easier to understand, a detailed description of the specific embodiments of the present application is provided below in conjunction with the accompanying drawings. It is to be understood that the specific embodiments described herein are merely for explaining the present application and are not intended to limit it. Additionally, it should be noted that, for ease of description, only the parts related to the present application are shown in the drawings, not the entire structure. According to the embodiments of the present application, all other embodiments obtained by those of ordinary skill in the art without exercising creative efforts fall within the scope of protection of the present application.

The terms “include” and “have” and any variations of them in the present application are intended to cover non-exclusive inclusion. For example, a process, system, product, or device that includes a series of steps or units is not limited to the listed steps or units, but optionally also includes steps or units that are not listed, or optionally also includes other steps or units that are inherent to these processes, systems, products, or devices.

The mention of “embodiments” in this document implies that specific features, structures, or characteristics described in conjunction with the embodiments can be included in at least one embodiment of the present application. The appearance of this phrase at various locations in the specification does not necessarily refer to the same embodiment, nor is it an independent or alternative embodiment that is mutually exclusive with other embodiments. Those of ordinary skill in the art explicitly and implicitly understand that the embodiments described herein can be combined with other embodiments.

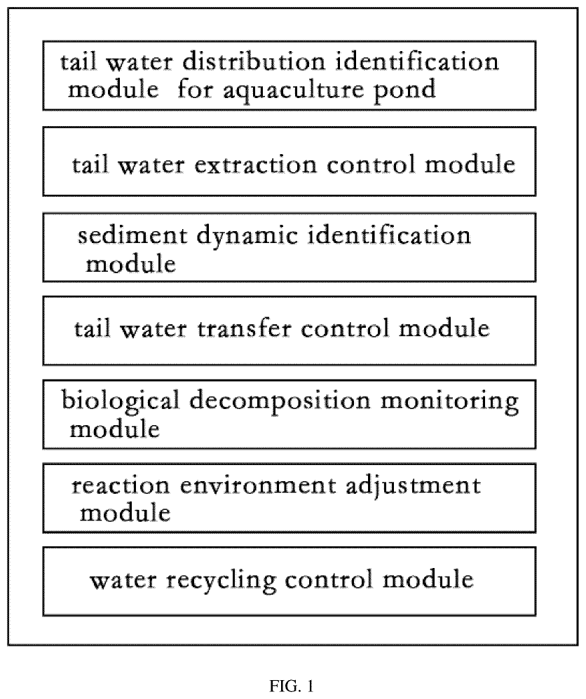

Please refer to FIG. 1 for an embodiment of the present application, which provides a tail water treatment and recycling system for aquaculture. The tail water treatment and recycling system for aquaculture comprises: a tail water distribution identification module for aquaculture ponds configured to identify the overall water body inside the aquaculture pond, determines the tail water distribution status information within the pond, and identifies the status information of the water body area where tail water extraction is needed based on this tail water distribution status information;
a tail water extraction control module configured to adjust the operational status of tail water extraction from the pond based on the water body area status information and transfers the extracted tail water to a sedimentation tank;
a sediment dynamic identification module configured to perform non-contact scanning and detection on the water body inside the sedimentation tank to obtain sediment settlement action data of the water body, and analyze this data to determine if sedimentation is complete within the tank;
a tail water transfer control module configured to adjust the extraction operational status for transferring tail water from the sedimentation tank to a decomposition tank based on the water body characteristic information inside the sedimentation tank when sedimentation is complete;
a biological decomposition monitoring module configured to monitor the decomposition process of tail water inside the decomposition tank to obtain decomposition reaction output data, and determine the reaction progress information inside the tank based on this data;
a reaction environment adjustment module configured to adjust the decomposition reaction environmental conditions inside the decomposition tank based on the reaction progress information;
a water circulation control module configured to adjust the delivery status of tail water that has completed the decomposition reaction being recycled and injected into the aquaculture pond based on real-time aquaculture status information of the pond, and adjust the oxygenation operation for this tail water based on the water body's oxygen content in the pond.

The beneficial effects of the above embodiment are that the tail water treatment and recycling system for aquaculture identifies the overall water body inside the aquaculture pond to determine the tail water distribution status information within the pond, thereby adjusting the operational status of tail water extraction from the pond to ensure comprehensive and complete extraction of tail water. It also performs non-contact scanning and detection on the water body inside the sedimentation tank, analyzes the sediment settlement action data of the water body inside the tank, and determines if sedimentation is complete, ensuring comprehensive and thorough precipitation and filtration of sediments. Furthermore, it monitors the decomposition process of tail water inside the decomposition tank to obtain decomposition reaction output data, thereby determining the reaction progress information inside the tank and adjusting the decomposition reaction environmental conditions inside the tank to maximize the biological decomposition reaction, effectively reducing the nutrient concentration of tail water. Additionally, based on real-time aquaculture status information of the pond, it adjusts the delivery status of tail water that has completed the decomposition reaction being recycled and injected into the aquaculture pond, and adjusts the oxygenation operation for this tail water based on the water body's oxygen content in the pond, ensuring that the pond can continuously and stably receive a clean and high-oxygen supply of recycled water.

In another embodiment, the tail water distribution identification module for aquaculture ponds is configured to identify the overall water body inside the pond to determine the tail water distribution status information within the pond, and identify the status information of the water body area where tail water extraction is needed based on this information, wherein, distributed water quality testing on the overall water body inside the pond is performed to obtain pollutant concentration change data for different regions of the overall water body; this data is analyzed to obtain the average pollutant concentration value and pollutant concentration change rate value for each region over a preset time period; if the average pollutant concentration value is greater than a preset concentration threshold and the pollutant concentration change rate value is less than a preset rate threshold, then classifying this region as a tail water-present region and calibrating the location information of this region inside the pond as the tail water distribution status information; and based on this tail water distribution status information, water flow detection on all tail water-present regions inside the pond is performed to obtain the water flow speed information for each region, and using this information along with the water body volume information as the status information for the water body areas inside the pond where tail water extraction is needed.

The beneficial effects of the above embodiment are that tail water formed in aquaculture has characteristics such as high pollutant concentration and low oxygen content, and the regions with denser distributions of aquatic products in the pond correspond to higher tail water content. By performing distributed water quality testing on the overall water body inside the pond to obtain pollutant concentration change data for different regions (i.e., pollutant concentration distribution change data over a preset time period), analyzing this data to obtain the average pollutant concentration value and pollutant concentration change rate value for each region, and comparing these values with thresholds to determine if pollutants are diffusing outward, if the average pollutant concentration value is greater than a preset concentration threshold and the pollutant concentration change rate value is less than a preset rate threshold, it indicates that pollutants in this region have not diffused outward in a timely manner, making the water body in this region tail water, and obtaining the tail water distribution status information for the pond. Additionally, based on this tail water distribution status information, performing water flow detection on all tail water-present regions inside the pond to obtain the water flow speed information for each region, and using this information along with the water body volume information for all tail water-present regions as the status information for the water body areas inside the pond where tail water extraction is needed, thereby comprehensively identifying the tail water distribution in the pond and providing a reliable basis for accurately extracting tail water from the pond.

In another embodiment, the tail water extraction control module is configured to adjust the operational status of tail water extraction from the pond based on the water body area status information and transfer the extracted tail water to a sedimentation tank, wherein, water flow simulation processing on the tail water-present region is performed based on its water flow speed information and water body volume information to determine the water flow path information inside the region; and based on this water flow path information, the extraction direction and extraction rate for tail water extraction from the tail water-present region to transfer the extracted tail water to the sedimentation tank is adjusted.

The beneficial effects of the above embodiment are that by performing water flow simulation processing on the tail water-present region based on its water flow speed information and water body volume information to determine the water flow path information inside the region, and adjusting the extraction direction and extraction rate for tail water extraction from the region based on this information to transfer the extracted tail water to the sedimentation tank, it ensures that all tail water inside the pond is timely and comprehensively extracted and transferred to the sedimentation tank.

In another embodiment, the precipitate dynamic identification module is configured to perform non-contact scanning detection on the water body inside the sedimentation basin to obtain the precipitate settlement motion data of the water body inside the sedimentation basin. It analyzes the precipitate settlement motion data to determine whether the water body inside the sedimentation basin has completed sedimentation, wherein,
laser irradiation detection on the water body inside the sedimentation basin during the sedimentation process is performed to obtain the scattering spectral characteristic information of the water body for the laser. Based on the scattering spectral characteristic information, the precipitate settlement velocity distribution data of the water body inside the sedimentation basin is obtained. This includes the settlement velocity distribution data of all precipitates on the cross-section corresponding to different water depths inside the sedimentation basin.

The precipitate settlement velocity distribution data is analyzed to obtain the precipitate settlement velocity change trend information inside the sedimentation basin. Based on this precipitate settlement velocity change trend information, it is determined whether the water body inside the sedimentation basin has completed sedimentation.

The beneficial effect of the above embodiment is that during the sedimentation process of the water body inside the sedimentation basin, precipitates at different positions inside the water body have different settlement velocities. When the laser irradiates precipitates with different settlement velocities, the precipitates have different scattering efficiencies for the laser irradiated onto them. The difference in scattering efficiency has a corresponding regularized relationship with the settlement velocity of the precipitates. By performing laser irradiation detection on the water body inside the sedimentation basin during the sedimentation process, the scattering spectral characteristic information of the water body for the laser is obtained. Based on this scattering spectral characteristic information, the precipitate settlement velocity distribution data of the water body inside the sedimentation basin is obtained, thereby accurately and comprehensively calibrating the precipitate settlement velocity of the water body inside the sedimentation basin. Furthermore, the precipitate settlement velocity distribution data is analyzed to obtain the precipitate settlement velocity change trend information inside the sedimentation basin. When the precipitate settlement velocity change trend information indicates that the overall settlement velocity of the precipitates gradually tends to zero, it is determined that the water body inside the sedimentation basin has completed sedimentation. Otherwise, it is determined that the water body inside the sedimentation basin has not completed sedimentation. This facilitates subsequent directional extraction and transfer of the sedimented tail water.

In another embodiment, the precipitate dynamic identification module is configured to perform non-contact scanning detection on the water body inside the sedimentation basin to obtain the precipitate settlement motion data of the water body inside the sedimentation basin. It analyzes the precipitate settlement motion data to determine whether the water body inside the sedimentation basin has completed sedimentation, wherein,
step S1: during the non-contact scanning detection of the water body inside the sedimentation tank, non-contact scanning detection is performed in multiple directions of the water body, and the following formula (1) is configured to screen out the primary detection direction for continued scanning detection based on the sediment settlement motion data of the water body inside the sedimentation tank obtained from the non-contact scanning detection in multiple directions,

$$\{ \begin{matrix}A 1 = arg {max}_{a = 1}^{D} [ N ( a ) ] \\ A 2 = arg {max}_{α = 1}^{D} [ \frac{{\sum }_{i = 1}^{N ( α )} {V}_{a} ( i )}{N ( a )} ]\end{matrix} \qquad ( 1 )$$

wherein, in the above formula (1), A1 represents selecting the A1th direction as the primary detection direction for continued scanning and detection; A2 represents selecting the A2th direction as the primary detection direction for continued scanning and detection; N(a) represents the number of precipitates in motion within the sediment settlement action data of the internal water body of the sedimentation basin, obtained through non-contact scanning detection in the ath direction; Va(i) represents the magnitude of the movement speed of the ith precipitate in motion within the sediment settlement action data of the internal water body of the sedimentation basin, obtained through non-contact scanning detection in the ath direction; D represents the total number of directions for non-contact scanning detection;

$$arg {max}_{a = 1}^{D} [ ]$$

indicates the value of a that yields the maximum value within the parentheses when a is substituted into the parentheses from 1 to D;
Step S2: the following formula (2) is configured to determine whether the water body inside the sedimentation tank has completed sedimentation in the primary detection direction based on the sediment settlement motion data of the water body inside the sedimentation tank detected in the primary detection direction,

$$\{ \begin{matrix}P ( A 1 ) = IF [ N ( A 1 ) + \frac{{\sum }_{i = 1}^{N ( A 1 )} {V}_{A 1} ( i )}{N ( A 1 )} = 0 ] \\ P ( A 2 ) = IF [ N ( A 2 ) + \frac{{\sum }_{i = 1}^{N ( A 2 )} {V}_{A 2} ( i )}{N ( A 2 )} = 0 ]\end{matrix} \qquad ( 2 )$$

wherein, in the above formula (2), P(A1) represents the detection value indicating whether precipitation is complete in the A1th direction; P(A2) represents the detection value indicating whether precipitation is complete in the A2th direction; N(A1) represents the number of precipitates in motion within the sediment settlement action data of the internal water body of the sedimentation basin, obtained through non-contact scanning detection in the A1th direction; N(A2) represents the number of precipitates in motion within the sediment settlement action data of the internal water body of the sedimentation basin, obtained through non-contact scanning detection in the A2th direction; VA1(i) represents the magnitude of the movement speed of the ith precipitate in motion within the sediment settlement action data of the internal water body of the sedimentation basin, obtained through non-contact scanning detection in the A1th direction; VA2(i) represents the magnitude of the movement speed of the ith precipitate in motion within the sediment settlement action data of the internal water body of the sedimentation basin, obtained through non-contact scanning detection in the A2th direction; IF[ ] represents a conditional function, which takes a value of 1 if the expression within the parentheses is true, and 0 if the expression within the parentheses is false;
Step S3, the following formula (3) is applied to determine whether the water body inside the sedimentation tank has completely settled based on the detection value indicating whether the settlement in the main detection direction of the water body inside the sedimentation tank is complete,

$$E = IF [ P ( A 1 ) = 1 ] \& IF [ P ( A 2 ) = 1 ] \qquad ( 3 )$$

in the formula (3), E represents the decision value indicating whether the water body inside the sedimentation tank has completely settled; “&” represents the logical AND relationship;

If E=1, it indicates that the water body inside the sedimentation tank has completely settled;

If E=0, it indicates that the water body inside.

The beneficial effects of the aforementioned embodiment lie in utilizing formula (1) to filter out the main detection direction for continued scanning and detection based on the sediment settlement motion data of the water body inside the sedimentation basin detected by non-contact scanning in multiple directions, thereby ensuring the efficient working capability of the system through targeted scanning and detection. Furthermore, formula (2) is employed to determine whether the water body inside the sedimentation basin has completed sedimentation in the primary detection direction based on the detected sediment settlement motion data in that direction, allowing for a singular analysis to obtain the sedimentation results for each primary detection direction. Finally, formula (3) is configured to ascertain whether the water body inside the sedimentation basin has undergone complete sedimentation based on the detection values pertaining to whether the water body has settled in the primary detection directions, thereby arriving at a final judgment through comprehensive consideration to ensure the accuracy and reliability of the system.

In another embodiment, the tail water transfer control module is configured to adjust the extraction operation status for transferring the tail water inside the sedimentation basin to the decomposition tank based on the water body characteristic information of the sedimentation basin when the water body inside has completed sedimentation.

This includes obtaining the water distribution position of the tail water inside the sedimentation basin that has settled and is in a clarified state, and adjusting the implementation area for extracting and transferring this clarified tail water to the decomposition tank based on this water distribution position information.

The beneficial effects of the aforementioned embodiment are that when the water body inside the sedimentation basin has completed sedimentation, the water distribution position of the settled and clarified tail water inside the sedimentation basin is obtained, thereby adjusting the real-time extraction area for transferring this clarified tail water to the decomposition tank. This ensures comprehensive and precise extraction and transfer of the settled and clarified tail water while avoiding the accidental extraction and transfer of sediment.

In another embodiment, the biological decomposition monitoring module monitors the tail water decomposition process inside the decomposition tank to obtain decomposition reaction output data, and determines the reaction progress information for the decomposition reaction occurring inside the decomposition tank based on this data.

This includes monitoring the tail water decomposition process inside the decomposition tank to obtain data on changes in the gas production rate and temperature during the decomposition reaction, and analyzing these data to obtain the reaction progress information for the decomposition reaction inside the decomposition tank.

The beneficial effects of the aforementioned embodiment are that the decomposition tank is configured for the biological decomposition of tail water, specifically employing bacteria to conduct aerobic decomposition reactions on the nutrients in the tail water, thereby reducing the degree of nutrient enrichment in the tail water. The decomposition reaction inside the decomposition tank generates heat and gaseous reaction products such as carbon dioxide or methane. By monitoring the tail water decomposition process inside the decomposition tank to obtain data on changes in the gas production rate and temperature during the decomposition reaction, and analyzing these data, the reaction progress information for the decomposition reaction inside the decomposition tank can be obtained. When the gas production rate of the decomposition reaction gradually decreases and the decomposition reaction temperature gradually lowers, it indicates that the decomposition reaction inside the decomposition tank is trending towards completion.

In another embodiment, the reaction environment adjustment module adjusts the decomposition reaction environmental conditions inside the decomposition tank based on the reaction progress information.

This includes determining whether the decomposition reaction inside the decomposition tank is in a completed state based on the reaction progress information, and reducing the oxygen supply rate inside the decomposition tank when the decomposition reaction is in a completed state. Conversely, the oxygen supply rate inside the decomposition tank is increased when the decomposition reaction is not in a completed state.

The beneficial effects of the aforementioned embodiment are that by determining whether the decomposition reaction inside the decomposition tank is in a completed state based on the reaction progress information, and reducing the oxygen supply rate inside the decomposition tank when the decomposition reaction is completed, the decomposition reaction inside the decomposition tank can be promptly halted. When the decomposition reaction inside the decomposition tank is not completed, increasing the oxygen supply rate inside the decomposition tank can accelerate the decomposition reaction speed.

In another embodiment, the water circulation control module adjusts the delivery status of tail water that has completed the decomposition reaction and is being recycled into the aquaculture pond based on real-time aquaculture status information for the aquaculture pond, and adjusts the oxygen enrichment operation for this tail water based on the water body's oxygen content in the aquaculture pond.

This includes determining the water volume gap information inside the aquaculture pond based on real-time aquatic product distribution density information for the aquaculture pond, adjusting the delivery flow rate of tail water that has completed the decomposition reaction and is being recycled into the aquaculture pond based on this water volume gap information, determining the rate of decline in the water body's oxygen content in the aquaculture pond based on changes in this data, and increasing the oxygen enrichment delivery rate for the tail water that has completed the decomposition reaction based on this rate of decline.

The beneficial effects of the aforementioned embodiment are that the real-time aquatic product distribution density information for the aquaculture pond is configured to determine the water volume gap information inside the aquaculture pond (i.e., the clean water gap volume information). Generally speaking, the higher the aquatic product distribution density, the greater the water volume gap value inside the aquaculture pond. Then, based on this water volume gap information, the delivery flow rate of tail water that has completed the decomposition reaction and is being recycled into the aquaculture pond is adjusted, ensuring that the aquaculture pond can promptly receive sufficient clean water replenishment. Additionally, based on changes in the water body's oxygen content in the aquaculture pond, the rate of decline in the water body's oxygen content is determined, and the oxygen enrichment delivery rate for the tail water that has completed the decomposition reaction is increased according to this rate, thereby supplementing the aquaculture pond's water body with sufficient oxygen.

Overall, this tail water treatment and recycling system for aquaculture identifies the overall water body inside the aquaculture pond to determine the tail water distribution status information, thereby adjusting the operation status for extracting tail water from the aquaculture pond to ensure comprehensive and complete extraction of tail water from the aquaculture pond. It also conducts non-contact scanning and detection of the water body inside the sedimentation basin, analyzes the sediment settlement motion data of the water body inside the sedimentation basin, and assesses this data to determine whether the water body inside the sedimentation basin has completed sedimentation, ensuring comprehensive and thorough sediment filtration. Furthermore, it monitors the tail water decomposition process inside the decomposition tank to obtain decomposition reaction output data, thereby determining the reaction progress information inside the decomposition tank, and subsequently adjusts the decomposition reaction environmental conditions inside the decomposition tank to maximize the biological decomposition reaction within and effectively reduce the nutrient concentration of the tail water. Additionally, based on real-time aquaculture status information for the aquaculture pond, it adjusts the delivery status of tail water that has completed the decomposition reaction and is being recycled into the aquaculture pond, and adjusts the oxygen enrichment operation for this tail water based on the water body's oxygen content in the aquaculture pond, ensuring that the aquaculture pond can consistently and stably receive a supply of clean, high-oxygen recycled water.

The aforementioned content is merely a specific embodiment of the application, and any improvements made based on the premise of the application's concept are considered within the scope of protection of the application.

1. A tail water treatment and recycling system for aquaculture, comprising:
a tail water distribution identification module for aquaculture ponds, which is configured to identify the overall water body inside the aquaculture pond to determine the tail water distribution status information within the aquaculture pond and determine the status information of the water body area within the aquaculture pond where tail water extraction is needed based on the tail water distribution status information;
a tail water extraction control module configured to adjust the operating state of tail water extraction from the aquaculture pond based on the status information of the water body area, thereby transferring the extracted tail water to a sedimentation tank;
a sediment dynamic identification module configured to perform non-contact scanning detection on the water body inside the sedimentation tank to obtain sediment settlement action data of the water body inside the sedimentation tank, and analyze the sediment settlement action data to judge whether the water body inside the sedimentation tank has completed sedimentation;
a tail water transfer control module configured to adjust the extraction operating state for transferring the tail water inside the sedimentation tank to a decomposition tank based on the water body characteristic information inside the sedimentation tank when the water body inside the sedimentation tank has completed sedimentation;
a biological decomposition monitoring module configured to monitor the tail water decomposition process inside the decomposition tank to obtain decomposition reaction output data of the tail water, and determine the reaction progress information of the decomposition reaction inside the decomposition tank based on the decomposition reaction output data;
a reaction environment adjustment module configured to adjust the decomposition reaction environmental conditions inside the decomposition tank based on the reaction progress information;
a water circulation control module configured to adjust the conveyance state of recycling the tail water that has completed the decomposition reaction back into the aquaculture pond based on real-time aquaculture status information of the aquaculture pond, and adjust the oxygenation enrichment operation for the tail water that has completed the decomposition reaction based on the oxygen content of the water body in the aquaculture pond.

2. The tail water treatment and recycling system for aquaculture according to claim 1, wherein,
the tail water distribution identification module for aquaculture ponds is configured to identify the overall water body inside the aquaculture pond to determine the tail water distribution status information within the aquaculture pond, and determine the status information of the water body area within the aquaculture pond where tail water extraction is needed based on the tail water distribution status information, wherein,
distributed water quality detection is performed on the overall water body inside the aquaculture pond to obtain pollutant concentration change data for different regions of the overall water body; the pollutant concentration change data is analyzed to obtain the average pollutant concentration value and the pollutant concentration change rate value of the region over a preset time period; if the average pollutant concentration value is greater than a preset concentration threshold and the pollutant concentration change rate value is less than a preset rate threshold, then the region is classified as a tail water presence region, and the location information of the tail water presence region inside the aquaculture pond is calibrated, which serves as the tail water distribution status information;
water flow detection is performed on all tail water presence regions inside the aquaculture pond based on the tail water distribution status information, to obtain the water flow speed information for all tail water presence regions, and then the water flow speed information and water volume information are applied for all tail water presence regions as the status information of the water body area within the aquaculture pond where tail water extraction is needed.

3. The tail water treatment and recycling system for aquaculture according to claim 2, wherein,
the tail water extraction control module is configured to adjust the operating state of tail water extraction from the aquaculture pond based on the status information of the water body area to transfer the extracted tail water to a sedimentation tank, wherein,
water flow simulation processing is performed on the tail water presence regions based on the water flow speed information and water volume information of the tail water presence regions to determine the water flow path information inside the tail water presence regions, the extraction direction and extraction rate for tail water extraction from the tail water presence regions are adjusted to transfer the extracted tail water to the sedimentation tank based on the water flow path information.

4. The tail water treatment and recycling system for aquaculture according to claim 3, wherein,
the sediment dynamic identification module is configured to perform non-contact scanning detection on the water body inside the sedimentation tank to obtain sediment settlement action data of the water body inside the sedimentation tank, the sediment settlement action data is analyzed to judge whether the water body inside the sedimentation tank has completed sedimentation, wherein,
laser irradiation detection on the water body inside the sedimentation tank during the sedimentation process is performed to obtain scattering spectrum characteristic information of the water body for the laser; sediment settlement speed distribution data of the water body inside the sedimentation tank is obtained based on the scattering spectrum characteristic information; wherein, the sediment settlement speed distribution data comprises sediment settlement speed distribution data for all sediments on the cross-sections corresponding to different water depths inside the sedimentation tank;
the sediment settlement speed distribution data is analyzed to obtain sediment settlement speed change trend information inside the sedimentation tank and then judge whether the water body inside the sedimentation tank has completed sedimentation based on the sediment settlement speed change trend information.

5. The tail water treatment and recycling system for aquaculture according to claim 4, wherein,
the sediment dynamic identification module is configured to perform non-contact scanning detection on the water body inside the sedimentation tank to obtain sediment settlement motion data of the water body inside the sedimentation tank; the sediment settlement motion data is analyzed to determine whether the water body inside the sedimentation tank has completed sedimentation, comprising:
step S1: during the non-contact scanning detection of the water body inside the sedimentation tank, non-contact scanning detection is performed in multiple directions of the water body, and the following formula (1) is configured to screen out the primary detection direction for continued scanning detection based on the sediment settlement motion data of the water body inside the sedimentation tank obtained from the non-contact scanning detection in multiple directions,
$$\{ \begin{matrix}A 1 = arg {max}_{a = 1}^{D} [ N ( a ) ] \\ A 2 = arg {max}_{α = 1}^{D} [ \frac{{\sum }_{i = 1}^{N ( α )} {V}_{a} ( i )}{N ( a )} ]\end{matrix} \qquad ( 1 )$$
wherein, in the above formula (1), A1 represents selecting the A1th direction as the primary detection direction for continued scanning and detection; A2 represents selecting the A2th direction as the primary detection direction for continued scanning and detection; N(a) represents the number of precipitates in motion within the sediment settlement action data of the internal water body of the sedimentation basin, obtained through non-contact scanning detection in the ath direction; Va(i) represents the magnitude of the movement speed of the ith precipitate in motion within the sediment settlement action data of the internal water body of the sedimentation basin, obtained through non-contact scanning detection in the ath direction; D represents the total number of directions for non-contact scanning detection;
$$arg {max}_{a = 1}^{D} [ ]$$
indicates the value of a that yields the maximum value within the parentheses when a is substituted into the parentheses from 1 to D;
Step S2: the following formula (2) is configured to determine whether the water body inside the sedimentation tank has completed sedimentation in the primary detection direction based on the sediment settlement motion data of the water body inside the sedimentation tank detected in the primary detection direction,
$$\{ \begin{matrix}P ( A 1 ) = IF [ N ( A 1 ) + \frac{{\sum }_{i = 1}^{N ( A 1 )} {V}_{A 1} ( i )}{N ( A 1 )} = 0 ] \\ P ( A 2 ) = IF [ N ( A 2 ) + \frac{{\sum }_{i = 1}^{N ( A 2 )} {V}_{A 2} ( i )}{N ( A 2 )} = 0 ]\end{matrix} \qquad ( 2 )$$
wherein, in the above formula (2), P(A1) represents the detection value indicating whether precipitation is complete in the A1th direction; P(A2) represents the detection value indicating whether precipitation is complete in the A2th direction; N(A1) represents the number of precipitates in motion within the sediment settlement action data of the internal water body of the sedimentation basin, obtained through non-contact scanning detection in the A1th direction; N(A2) represents the number of precipitates in motion within the sediment settlement action data of the internal water body of the sedimentation basin, obtained through non-contact scanning detection in the A2th direction; VA1(i) represents the magnitude of the movement speed of the ith precipitate in motion within the sediment settlement action data of the internal water body of the sedimentation basin, obtained through non-contact scanning detection in the A1th direction; VA2(i) represents the magnitude of the movement speed of the ith precipitate in motion within the sediment settlement action data of the internal water body of the sedimentation basin, obtained through non-contact scanning detection in the A2th direction; IF[ ] represents a conditional function, which takes a value of 1 if the expression within the parentheses is true, and 0 if the expression within the parentheses is false;
Step S3, the following formula (3) is applied to determine whether the water body inside the sedimentation tank has completely settled based on the detection value indicating whether the settlement in the main detection direction of the water body inside the sedimentation tank is complete,
$$E = IF [ P ( A 1 ) = 1 ] \& IF [ P ( A 2 ) = 1 ] \qquad ( 3 )$$
in the formula (3), E represents the decision value indicating whether the water body inside the sedimentation tank has completely settled; “&” represents the logical AND relationship;
If E=1, it indicates that the water body inside the sedimentation tank has completely settled;
If E=0, it indicates that the water body inside the sedimentation tank has not completely settled.

6. The tail water treatment and recycling system for aquaculture according to claim 4, wherein,
the tail water transfer control module is configured to, when the water body inside the sedimentation tank has settled completely, adjust the extraction operation status for transferring the settled tail water in the sedimentation tank to a decomposition tank based on the water body characteristic information inside the sedimentation tank, wherein,
when the water body inside the sedimentation tank has settled completely, the distribution location of the settled and clarified tail water inside the sedimentation tank is obtained, and the real-time extraction area for transferring the settled and clarified tail water inside the sedimentation tank to the decomposition tank is adjusted based on the information of the water body distribution location.

7. The tail water treatment and recycling system for aquaculture according to claim 6, wherein,
the biological decomposition monitoring module is configured to monitor the tail water decomposition process inside the decomposition tank to obtain decomposition reaction output data of the tail water; and determine reaction progress information of the decomposition reaction occurring inside the decomposition tank based on the decomposition reaction output data, wherein,
the tail water decomposition process inside the decomposition tank is monitored to obtain tail water decomposition reaction gas production rate variation data and decomposition reaction temperature variation data;
the decomposition reaction gas production rate variation data and the decomposition reaction temperature variation data are analyzed to obtain the reaction progress information of the decomposition reaction occurring inside the decomposition tank.

8. The tail water treatment and recycling system for aquaculture according to claim 6, wherein,
the reaction environment adjustment module is configured to adjust the decomposition reaction environmental conditions inside the decomposition tank based on the reaction progress information, wherein
whether the decomposition reaction inside the decomposition tank is in a completed state is determined based on the reaction progress information; when the decomposition reaction inside the decomposition tank is in a completed state, the oxygen supply rate inside the decomposition tank is reduced; when the decomposition reaction inside the decomposition tank is not in a completed state, the oxygen supply rate inside the decomposition tank is increased.

9. The tail water treatment and recycling system for aquaculture according to claim 6, wherein,
the water circulation control module is configured to adjust the delivery status of tail water, which has completed the decomposition reaction, being recycled and injected into the aquaculture tank, based on real-time aquaculture status information of the aquaculture tank, and to adjust the oxygen enrichment operation for the tail water that has completed the decomposition reaction, based on the dissolved oxygen content in the water body of the aquaculture tank, wherein,
water volume deficit information inside the aquaculture tank is determined based on real-time aquatic product distribution density information of the aquaculture tank; the delivery flow rate of tail water is adjusted, which has completed the decomposition reaction, being recycled and injected into the aquaculture tank, based on the water volume deficit information;
the rate of decrease in dissolved oxygen content in the water body of the aquaculture tank is determined based on dissolved oxygen content variation data of the water body of the aquaculture tank; the oxygen enrichment delivery rate for the tail water that has completed the decomposition reaction is increased based on the rate of decrease in dissolved oxygen content.
